(19) United States
(12) Patent Application Publication
(10) Pub. No.: US 2019/0266378 A1
(43) Pub. Date: Aug. 29, 2019

(54) PORTABLE ELECTRONIC DEVICE

(71) Applicant: Chiun Mai Communication Systems, Inc., New Taipei (TW)

(72) Inventor: CHEN-SHENG HSU, New Taipei (TW)

(21) Appl. No.: 16/287,650

(22) Filed: Feb. 27, 2019

(30) Foreign Application Priority Data
Feb. 28, 2018 (CN) 201810166665.8

(51) Int. Cl. G06K 9/00; G06F 1/16; G06F 3/041

(52) U.S. Cl. CPC G06K 9/00013; G06F 1/1684; G06F 3/041; G06F 1/1626

(57) ABSTRACT

A portable electronic device includes a protection layer, a display panel, a fingerprint sensor, and a processor. The protection layer, the display panel, and the fingerprint sensor are stacked, the protection layer being the outermost layer. The protection layer includes a non-planar area. The fingerprint sensor is correspondingly disposed in the non-planar area of the display panel and configured to detect fingerprints on the non-planar area. The processor is configured to compare a fingerprint detected by the fingerprint sensor to predetermined fingerprints and execute a predetermined function when the detected fingerprint matches one of the predetermined fingerprints.

### FIELD

The subject matter herein generally relates to a portable electronic device having a non-planar area.

### BACKGROUND

Portable electronic devices may include fingerprint identifying technology. In general, a fingerprint identifying module may be arranged under a housing or a display of the portable electronic device. However, the display or other background of the identifying module needs to arrange an icon or an identifying zone when it is activated, so the user can find the right area for presenting his fingerprint. The arrangement of the fingerprint identifying module and the display is not optimal, in the sense of making it easier for the user to find the right area for fingerprints presentation.

### BRIEF DESCRIPTION OF THE DRAWINGS

Implementations of the present technology will now be described, by way of example only, with reference to the attached figures.

FIG. 1 is a cross-sectional view of a first embodiment of a portable electronic device.

FIG. 2 is a functional block of the portable electronic device shown in FIG. 1.

FIG. 3 is a cross-sectional view of a second embodiment of a portable electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. The term “comprising,” when utilized, means “including, but not necessarily limited to”; it specifically indicates open-ended inclusion or membership in the so-described combination, group, series, and the like.

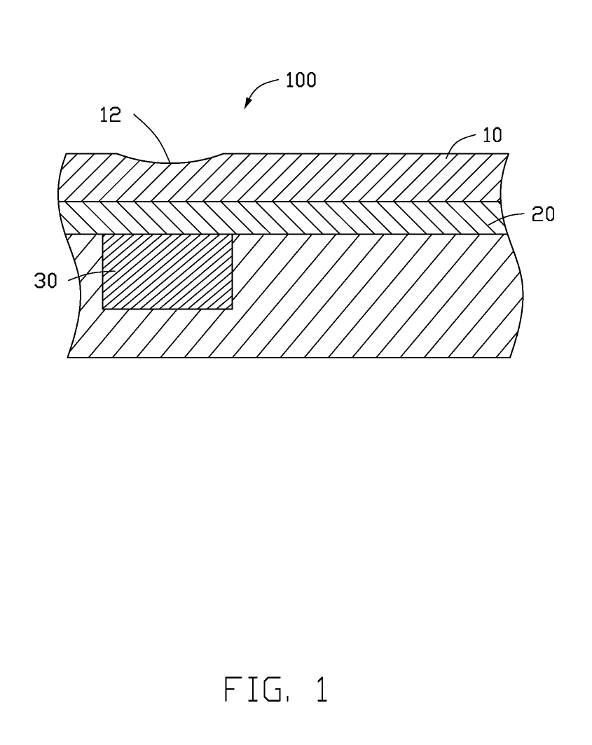

FIG. 1 illustrates a first embodiment of a portable electronic device 100. The portable electronic device 100 can be a mobile phone, a tablet computer, or a personal digital assistant (PDA).

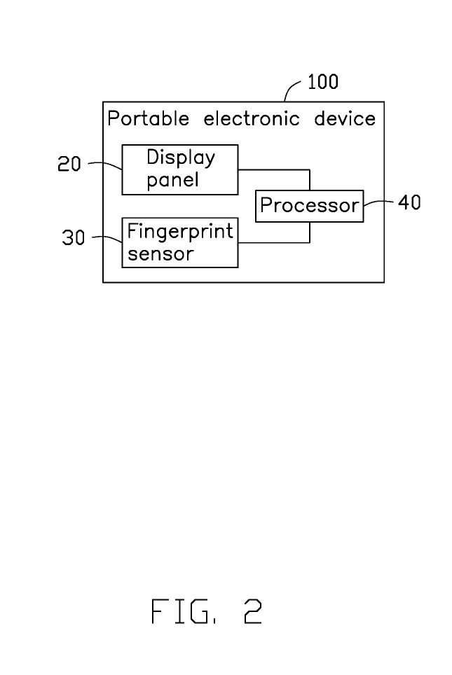

Referring to FIGS. 1 and 2, the portable electronic device 100 includes a protection layer 10, a display panel 20, a fingerprint sensor 30, and a processor 40. The processor 40 is electrically connected to the display panel 20 and the fingerprint sensor 30 for executing displaying and identifying fingerprints functions.

The protection layer 10, the display panel 20, and the fingerprint sensor 30 are stacked. The protection layer 10 is an outermost layer of the portable electronic device 100, the display panel 20 is under the protection layer 10, and the fingerprint sensor 30 is under the display panel 20 and opposites to the protection layer 10.

The protection layer 10 is an integral structure and defines a non-planar area 12. Other areas of the protection layer 10 are flat except for the non-planar area 12. The non-planar area 12 can be different in shape or profile, such as a recess or a protrusion. In at least one embodiment, the non-planar area 12 is a recess as shown in FIG. 1. The non-planar area 12 is recessed inwardly from top surface of the protection layer 10, towards the display panel 20. The protection layer 10 is configured to protect electronic elements of the portable electronic device 100 and can receive touch inputs from the user.

In at least one embodiment, the protection layer 10 can be made of glass material, such as 3D glass material. When the non-planar area 12 is a recess as shown in FIG. 1, a thickness of the non-planar area 12 is thinner than other areas of the protection layer 10, allowing fingerprints received by the non-planar area 12 to be closer to the fingerprint sensor 30.

The display panel 20 is configured to display a user interface of the portable electronic device 100. The display panel 20 includes a switched-on status and a switched-off status.

The fingerprint sensor 30 is correspondingly disposed in the non-planar area 12. The fingerprint sensor 30 is configured to detect fingerprints touched on the non-planar area 12 and transmit the detected fingerprints to the processor 40.

The processor 40 is configured to process the detected fingerprints transmitted from the fingerprint sensor 30 and compare the detected fingerprints to predetermined fingerprints. When a detected fingerprint and one of the predetermined fingerprints is found to match, the processor 40 executes a function corresponding to the matched fingerprint. The function can be, but is not limited to, unlocking, confirming, paying, and security identification.

In at least one embodiment, the protection layer 10 defining the non-planar area 12, the non-planar area 12 has a different structure and is configured to sense touches from other areas of the protection layer 10, which allows the user to easily identify the non-planar area 12 when the display panel 20 is in the switched-off status. Additionally, the fingerprint sensor 30 is correspondingly located to and close to the non-planar area 12, which facilitates the fingerprint sensor 30 taking and detecting fingerprints on the non-planar area 12 directly and rapidly. The processor 40 processes the detected fingerprints transmitted from the fingerprint sensor 30 and compares the detected fingerprints to the predetermined fingerprints. When a detected fingerprint and one of the predetermined fingerprints is found to match, the processor 40 executes a function corresponding to the matched fingerprint.

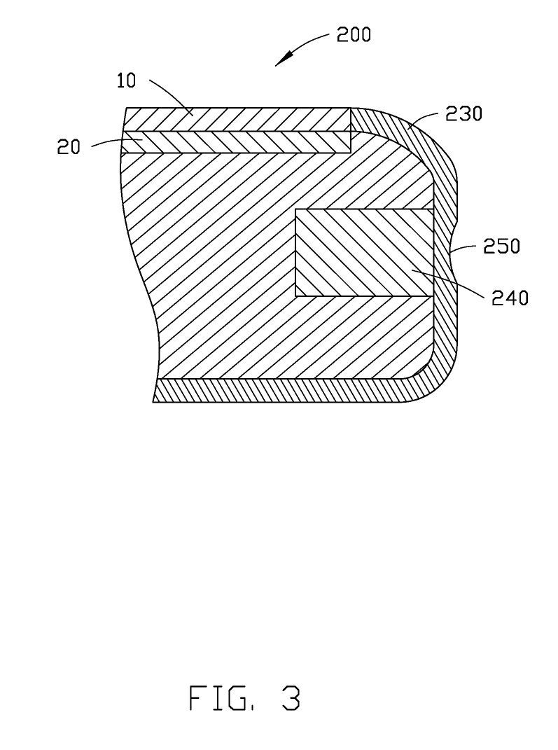

FIG. 3 illustrates a second embodiment of a portable electronic device 200. The portable electronic device 200 includes a protection layer 10, a display panel 20, a housing 230, and a button sensor 240. The protection layer 10 and the display panel 20 are stacked in an opening defined in a front wall of the housing 230.

In this embodiment, a side wall of the housing 230 defines a button area 250. The button area 250 can be in different shapes and profiles, such as a recess or a protrusion. In this embodiment, the button area 250 is a recess as shown in FIG. 3.

The button sensor 240 corresponds to and is close to the button area 250. The button sensor 240 is configured to detect touches on the button area 250. In this embodiment, the button sensor 240 can be, but is not limited to, a fingerprint sensor and a pressure sensor. When the button sensor 240 is a fingerprint sensor, the button sensor 240 is configured to detect fingerprints touched on the button area 250, which is functionally similar to the fingerprint sensor 30 in the first embodiment. When the button sensor 240 is a pressure sensor, the button sensor 240 is configured to detect and measure pressures received by the button area 250 and transmit to the processor 40. In this embodiment, the button sensor 240 as a pressure sensor is described.

In this embodiment, the housing 230 defining the button area 250, the button area 250 has different structure and sense of touch from other area of the housing 230, which enables the user to easily identify the non-planar area 12 even in darkness. Additionally, the button sensor 240 is corresponding to and close to the button area 250, which enables the button sensor 240 to directly and rapidly detect pressure received on the button area 250. The processor 40 determines whether the detected pressure exceeds a predetermined value. When the detected pressure does exceed a predetermined value, the processor 40 executes a function corresponding to the button area 250. The function can be, but is not limited to, power switching and volume adjusting.

In this embodiment, the housing 230 can be a same material as the protection layer 10, which is glass material integral with the housing 230. In other embodiments, the housing 230 can be a different material from the protection layer 10. In one embodiment, the housing 230 can be made of plastic or ceramic.

In other embodiments, the button area 250 can be defined on other part of the housing 230 other than the present area. In one embodiment, the button area 250 is on a front wall or a back wall of the housing 230.

The portable electronic device 100 defines the non-planar area 12 on the protection layer 10 and the button area 250 on the housing 230, which enables the user to easily identify the non-planar area 12 when the display panel 20 is in the switched-off status and the button area 250 when even in darkness. Additionally, fingerprints and touches on the non-planar area 12 or the button area 250 are closer to the fingerprint sensor 30 or button sensor 240, which makes detection of the fingerprints and touches easier.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A portable electronic device, comprising:
a protection layer comprising a non-planar area;
a display panel;
a fingerprint sensor correspondingly disposed in the non-planar area of the display panel, the fingerprint sensor configured to detect fingerprints on the non-planar area; and
a processor configured to compare a fingerprint detected by the fingerprint sensor to predetermined fingerprints and execute a predetermined function when the detected fingerprint matches one of the predetermined fingerprints;
wherein the protection layer, the display panel, and the fingerprint sensor are stacked.

2. The portable electronic device as claimed in claim 1, wherein the protection layer is an outermost layer of the portable electronic device, the display panel is under the protection layer, and the fingerprint sensor is under the display panel opposites to the protection layer.

3. The portable electronic device as claimed in claim 1, wherein the protection layer is made of glass material, other areas of the protection layer are flat except for the non-planar area.

4. The portable electronic device as claimed in claim 3, wherein the non-planar area is a recess or a protrusion.

5. The portable electronic device as claimed in claim 1, further comprising a housing and a button sensor, wherein the protection layer and the display panel are stacked in an opening defined in a front wall of the housing, a side wall of the housing defines a button area, the button sensor is correspondingly located to and close to the button area, the button sensor is configured to detect touches on the button area.

6. The portable electronic device as claimed in claim 5, wherein the button area is a non-planar structure.

7. The portable electronic device as claimed in claim 6, wherein the button area is a recess or a protrusion.

8. The portable electronic device as claimed in claim 5, wherein the button sensor is a fingerprint sensor and configured to detect fingerprints on the button area.

9. The portable electronic device as claimed in claim 5, wherein the button sensor is a pressure sensor and configured to detect pressures on the button area.

10. The portable electronic device as claimed in claim 5, wherein the housing and the protection layer is an integral structure and is made of a glass material.

11. The portable electronic device as claimed in claim 5, wherein the housing is made of plastic or ceramic, the housing being made of a different material from the protection layer.
